(19) United States
(12) Patent Application Publication
(10) Pub. No.: US 2007/0268893 A1
(43) Pub. Date: Nov. 22, 2007

(54) INTERNET TELEPHONY GATEWAY AND METHOD FOR DETECTING CONNECTION ERROR THEREOF

(75) Inventors: WEN-HSIN LO, Taipei Hsien (TW); JIN-HUE LIN, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/608,810

(22) Filed: Dec. 9, 2006

(30) Foreign Application Priority Data
May 19, 2006 (TW) 095117951

(51) Int. Cl. H04L 12/66

(52) U.S. Cl. 370/356

(57) ABSTRACT

A method is provided for detecting connection errors in an Internet telephony gateway (ITG) including a subscriber line interface controller (SLIC). The method includes initializing the SLIC for enabling the SLIC to operate in a forward active state; determining a connection status of the port; enabling the SLIC to operate in a reverse active state if the port is connected; determining whether the SLIC is in an open state after setting the SLIC in the reverse active state; generating connection error information if the SLIC is in the open state, for indicating that a connection error has occurred in the port. An ITG employing the method is also provided.

### BACKGROUND OF THE INVENTION

1. Field of the Invention

The invention relates to a gateway and method for detecting connection errors thereof, and particularly to an Internet telephony gateway and method for detecting connection errors thereof.

2. Description of Related Art

An Internet telephony gateway, such as an integrated access device (IAD) or a multimedia terminal adapter (MTA) for providing both traditional phone and Internet phone functions, is usually equipped with a foreign exchange service (FXS) port and a foreign exchange office (FXO) port. The FXS port and the FXO port are both RJ-11 standard ports, respectively connected to an Internet telephony service and a central office (CO) via different wires. For example, the FXS port must be connected to a VoIP wire, and the FXO port must be connected to a PSTN wire. Typically, a subscriber line interface controller (SLIC) is disposed in the Internet telephony gateway to detect operation status of the FXS port.

Due to a fact that the FXS port is of the same type as the FXO port, a subscriber is prone to erroneously connect the CO wire to the FXS port, or connect the Internet telephony wire to the FXO port. Consequently, a connection error occurs in the Internet telephony gateway, and in a more critical state, the Internet telephony gateway may be damaged due to different loop current.

Therefore, a heretofore unaddressed need exists in the industry to overcome the aforementioned deficiencies and inadequacies.

### SUMMARY OF THE INVENTION

An exemplary embodiment of the invention provides an Internet telephony gateway. The Internet telephony gateway includes at least one port, a subscriber line interface controller (SLIC), and a control system. The SLIC detects a connection status of the port. The control system includes an initiation control module, an information reading module, and a state setting module. The initiation control module initializes the SLIC. The information reading module reads information from the SLIC. The state setting module sets states of the SLIC.

Another exemplary embodiment of the invention provides a method for detecting connection errors in an Internet telephony gateway (ITG) comprising a subscriber line interface controller (SLIC). The method includes initializing the SLIC for enabling the SLIC to operate in a forward active state; determining a connection status of the port; enabling the SLIC to operate in a reverse active state if the port is connected; determining whether the SLIC is in an open state after setting the SLIC in the reverse active state; generating connection error information if the SLIC is in the open state, for indicating that a connection error has occurred in the port.

Other advantages and novel features will become more apparent from the following detailed description when taken in conjunction with the accompanying drawings, in which:

### BRIEF DESCRIPTION OF THE DRAWINGS

FIG. 1 is a block diagram of an Internet telephony gateway of an exemplary embodiment of the present invention; and

FIG. 2 is a flowchart of a method for detecting connection errors of the Internet telephony gateway of an exemplary embodiment of the present invention.

### DETAILED DESCRIPTION OF THE INVENTION

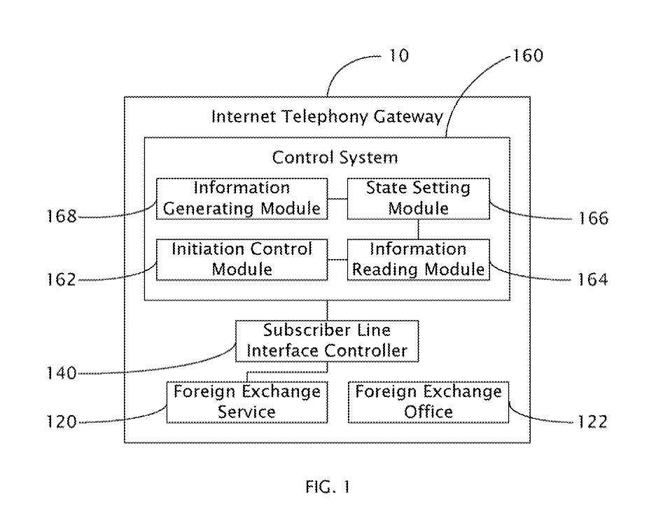

FIG. 1 is a block diagram of an Internet telephony gateway (ITG) 10 of an exemplary embodiment of the present invention.

The ITG 10 includes a foreign exchange service (FXS) port 120, a foreign exchange office (FXO) port 122, a subscriber line interface controller (SLIC) 140, and a control system 160.

The FXS port 120 and the FXO port 122 are respectively connectable to an Internet telephony service and a central office (CO) via different wires or cables.

The SLIC 140 detects connection status of the FXS port 120. In this embodiment, the SLIC 140 is an integrated circuit (IC) for setting tip voltage and ring voltage thereof and determining connection status of the FXS port 120 by detecting a tip current and a ring current received by the SLIC 140.

The SLIC 140 includes three states, a forward active state, a reverse active state, and an open state. The forward active state indicates that the tip voltage of the SLIC 140 is greater than the ring voltage thereof. The reverse active state indicates that the tip voltage of the SLIC 140 is less than the ring voltage thereof. The open state indicates that the tip voltage of the SLIC 140 is substantially equal to the ring voltage thereof.

The SLIC 140 has an over-current protection function. When a difference between the ring current and the tip current is greater than a threshold current value, the SLIC 140 enters the open state.

The control system 160 includes an initiation control module 162, an information reading module 164, a state setting module 166, and an information generating module 168.

The initiation control module 162 initializes the SLIC 140. After initialization, the SLIC 140 operates in a forward active state. In this state, a threshold current value and a minimum current value of the tip and the ring of the SLIC 140 are successfully set, and an over-current protection function of the SLIC 140 is enabled.

The information reading module 164 reads information from the SLIC 140, to determine the connection status of the FXS port 120, and determine whether the SLIC 140 is in the open state.

The state setting module 166 sets states of the SLIC 140 by setting the tip voltage and the ring voltage thereof.

The information generating module 168 generates an error alarm when a connection error occurs. In this embodiment, the information generating module 168 includes a light emitting diode or a speaker respectively generating visible light or audible sound for notifying the subscriber.

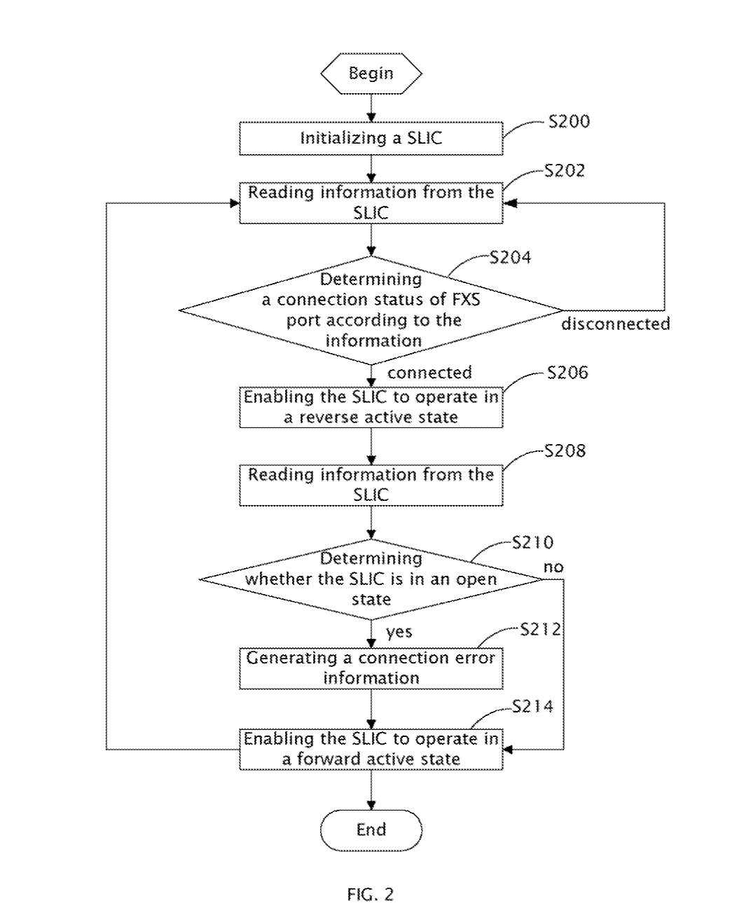

FIG. 2 is a flowchart of a method for detecting connection errors of the ITG 10 of an exemplary embodiment of the present invention.

In step S200, the initiation control module 162 initializes the SLIC 140. In detail, the initiation control module 162 enables the SLIC 140 to operate in the forward active state, sets a threshold current value and a minimum current value of the tip and the ring of the SLIC 140, and enables the over-current protection function of the SLIC 140.

In step S202, the information reading module 164 reads information from the SLIC 140.

In this exemplary embodiment, the information reading module 164 reads the tip current and the ring current of the SLIC 140 from a register of the SLIC 140.

In step S204, the information reading module 164 determines the connection status of the FXS port 120 according to the information. If the FXS port 120 is connected, the process proceeds to step S206. If the FXS port 120 is not connected, the process returns to step S202.

In this exemplary embodiment, the information reading module 164 determines the connection status of the FXS port 120 by determining whether the difference between the tip current and the ring current of the SLIC 140 is greater than the minimum current value thereof.

In step S206, the state setting module 166 enables the SLIC 140 to operate in the reverse active state, in which, the tip voltage of the SLIC 140 is less than the ring voltage thereof.

In step S208, the information reading module 164 reads information from the SLIC 140 again.

In step S210, the information reading module 164 determines whether the SLIC 140 is in the open state. If the SLIC 140 is in the open state, the process proceeds to step S212. If the SLIC 140 is not in the open state, the process proceeds to step S214.

In this exemplary embodiment, the information reading module 164 determines whether the SLIC 140 is in the open state by determining whether the tip voltage of the SLIC 140 is substantially equal to a ring voltage thereof.

In step S212, if the SLIC 140 is in the open state, the information generating module 168 generates an error alarm, to indicate that a connection error has occurred in the FXS port 120.

In this exemplary embodiment, the information generating module 168 generates the error alarm by turning on the light emitting diode for notifying the subscriber.

In step S214, the state setting module 166 enables the SLIC 140 to operate in the forward active state, the process then returns to step S202.

The ITG 10 and method for detecting connection errors thereof detect whether a connection error occurs in the FXS port 120 of the ITG 10 via the SLIC 140 and the control system 160, thereby, the connection error can be discovered immediately without causing connection error and damaging the ITG 10.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An Internet telephony gateway comprising:
at least one port;
a subscriber line interface controller (SLIC), for detecting a connection status of the port; and
a control system comprising:
an initiation control module for initializing the SLIC;
an information reading module for reading information from the SLIC; and
a state setting module for setting states of the SLIC.

2. The Internet telephony gateway as recited in claim 1, wherein the port comprises a foreign exchange service port and a foreign exchange office port.

3. The Internet telephony gateway as recited in claim 1, further comprising an information generating module for generating an error alarm.

4. The Internet telephony gateway as recited in claim 3, wherein the information generating module comprises a light emitting diode, and the light emitting diode is turned on for indicating a connection error.

5. The Internet telephony gateway as recited in claim 3, wherein the information generating module comprises a speaker, and the speaker generates sound for indicating a connection error.

6. The Internet telephony gateway as recited in claim 1, wherein the states of the SLIC comprise a forward active state, and the forward active state indicates that a tip voltage of the SLIC is greater than a ring voltage thereof.

7. The Internet telephony gateway as recited in claim 1, wherein the states of the SLIC comprise a reverse active state, and the reverse active state indicates that a tip voltage of the SLIC is less than a ring voltage thereof.

8. The Internet telephony gateway as recited in claim 1, wherein the states of the SLIC comprise an open state, and the open state indicates that a tip voltage of the SLIC is substantially equal to a ring voltage thereof.

9. A method for detecting connection errors, in an Internet telephony gateway comprising a subscriber line interface controller (SLIC), the method comprising:
initializing the SLIC for enabling the SLIC to operate in a forward active state;
determining a connection status of a port;
enabling the SLIC to operate in a reverse active state, if the port is connected;
determining whether the SLIC is in an open state after enabling the SLIC to operate in a reverse active state; and
generating connection error information for indicating that a connection error has occurred in the port, if the SLIC is in the open state.

10. The method as recited in claim 9, wherein the step of initializing the SLIC further comprises setting a threshold current value of the tip and the ring of the SLIC.

11. The method as recited in claim 9, wherein the step of initializing the SLIC further comprises setting a minimum current value of the tip and the ring of the SLIC.

12. The method as recited in claim 9, wherein the step of initializing the SLIC further comprises enabling an over-current protection function of the SLIC.

13. The method as recited in claim 9, further comprising a step of reading information from the SLIC after initializing the SLIC.

14. The method as recited in claim 9, further comprising a step of reading information from the SLIC after enabling the SLIC to operate in a reverse active state.

15. The method as recited in claim 14, further comprising a step of enabling the SLIC to operate in the forward active state and reading information from the SLIC, if the SLIC does not enter the open state.

16. A method for detecting port connection errors of an Internet telephony gateway, comprising steps of:
initializing a controller of an Internet telephony gateway to operate in a first state of said controller in order for detecting a connection status of a connection port of said gateway;
enabling said controller to operate in a second state thereof when said port is determined to be connected by said controller previously in said first state thereof; and
generating connection error information to indicate a connection error occurs in said port when said controller in said second state thereof enters a third state thereof from said second state thereof in response to said connection error of said port.

17. The method as recited in claim 16, wherein said controller is a subscriber line interface controller (SLIC), and said first, second and third states are a forward active state, a reverse active state and an open state, respectively.
